(19) United States
(12) Patent Application Publication
(10) Pub. No.: US 2006/0069857 A1
(43) Pub. Date: Mar. 30, 2006

(54) Compression system and method

(75) Inventors: Haris Lekatsas, Princeton, NJ (US); Joerg Henkel, Exton, PA (US); Venkata Jakkula, Monmouth Junction, NJ (US); Srimat T. Chakradhar, Manalapan, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/095,221

(22) Filed: Mar. 31, 2005

Related U.S. Application Data
(60) Provisional application No. 60/522,390, filed on Sep. 24, 2004.

(51) Int. Cl. G06F 12/00

(52) U.S. Cl. 711/108; 711/154

(57) ABSTRACT

A new compression and decompression architecture is herein disclosed which advantageously uses a plurality of parallel content addressable memories of different sizes to perform fast matching during compression.

This application claims the benefit of U.S. Provisional Application No. 60/522,390, “COMPRESSION SYSTEM AND METHOD,” filed on Sep. 24, 2004, the contents of which is hereby incorporated by reference.

### BACKGROUND OF THE INVENTION

The present invention relates to compression and decompression architectures.

Compression techniques are well-known. One advantageous approach to compression of data is referred to in the art as “dictionary” coding, in which groups of recurring data are replaced by an index to an entry in a dictionary. A particularly useful example of dictionary coding is an adaptive scheme known generally in the art as Lempel-Ziv (LZ) coding. See, e.g., T. A. Welch, “A Technique for High-Performance Data Compression,” IEEE Computer, pp. 8-19 (1986). Data compression techniques have been utilized in a wide range of applications including, more recently, to compress data stored in main memory. Such applications require good hardware implementations and acceptable compression performance even on small data blocks. For example, “X-Match” is a recent compression architecture that compresses main memory using an adaptive dictionary coding scheme implemented with content addressable memory. See M. Kjelsø, M. Gooch, S. Jones, “Design and Performance of a Main Memory Hardware Data Compressor,” IEEE Proceedings of EUROMICRO-22, pp. 423-30 (September 1996).

### SUMMARY OF THE INVENTION

A new compression and decompression architecture is herein disclosed which advantageously uses a plurality of parallel content addressable memories of different sizes to perform fast matching during compression. In accordance with an embodiment of the invention, portions of an input stream are provided in parallel to the plurality of content addressable memories, where each content addressable memory performs matching on a different size portion of the input stream and where the content addressable memories are preferably shiftable content addressable memories. If there is a match to an entry in any one of the content addressable memories, a selection logic is used to choose one of the matching entries (preferably the longest match or the best partial match) and replace the matching portion of the input stream with a compressed representation that includes an index to the entry in the particular content addressable memory. The content addressable memories preferably also signal partial matches. When there is a partial match, the selection logic can replace the matching bytes with an index to the partially matching entry while including a representation of those bytes that do not match. The content addressable memory with the matching entry also preferably shifts the matching and partially matching entry to the top of the content addressable memory in order to facilitate a move-to-front strategy. In accordance with another embodiment of the invention, a compressed stream can be decompressed by decoding the compressed representations of matches and partial matches in the compressed stream. Conventional memories can be used to store the entries during decompression since no matching is necessary.

The present invention provides high performance compression and decompression of both code and data and is suitable for efficient hardware implementation, in particular in embedded systems. These and other advantages of the invention will be apparent to those of ordinary skill in the art by reference to the following detailed description and the accompanying drawings.

### BRIEF DESCRIPTION OF THE DRAWINGS

FIG. 1 is a block diagram of a compression architecture in accordance with an embodiment of the present invention.

FIG. 2 is a block diagram of a decompression architecture in accordance with an embodiment of the present invention.

FIG. 3 is an illustrative format for the compressed output.

FIGS. 4A, 4B, 4C, and 4D illustrate the different kinds of matches that can be handled by the architecture depicted in FIG. 1.

FIG. 5 is pseudo-code illustrating the compression processing performed in accordance with an embodiment of the present invention.

FIG. 6 is pseudo-code illustrating the decompression processing performed in accordance with an embodiment of the present invention.

### DETAILED DESCRIPTION

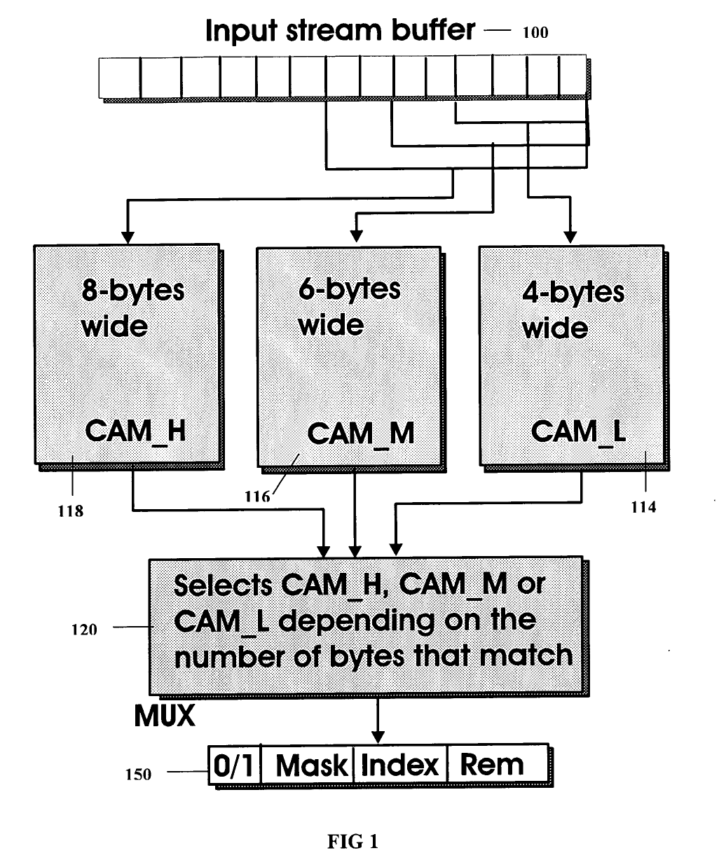

FIG. 1 is a block diagram of a compression architecture in accordance with an embodiment of the present invention. The compression architecture receives an input stream 100, for example from a buffer. The input stream 100 advantageously can be either code or data. Portions of the input stream 100 shall be referred to herein, for illustration purposes only, at the granularity of byte sequences. The compression architecture comprises a plurality of content addressable memories (CAMs) 114, 116, 118 which are each capable of storing a byte sequence and providing an index to the byte sequence stored in the content addressable memory. Although three content addressable memories are depicted in FIG. 1, any number of content addressable memories including two or greater can be utilized in the context of the described architecture. The inventors have found three content addressable memories to perform better than two, while the additional benefit of four or more was found to be marginal.

The content addressable memories 114, 116, 118 advantageously operate in parallel and are each of a different fixed size. Illustratively in FIG. 1, content addressable memory 114 processes byte sequences which are four bytes wide while content addressable memory 116 processes byte sequences which are six bytes wide while content addressable memory 118 processes byte sequences which are eight bytes wide. The content addressable memories 114, 116, 118 are preferably shiftable so as to better facilitate the growth of matching entries and to exploit the locality of common matches, as further described below.

As the input stream 100 is processed by the compression architecture, byte sequences of different lengths are stored in the content addressable memories 114, 116, 118. These initial unmatched byte sequences are passed along to selection logic 120 which processes them to create the beginning of an output stream 150. These initial byte sequences are stored in uncompressed format in the output stream 150 and are used to fill up the content addressable memories 114, 116, 118 until a match or a partial match is encountered. When a next portion of the input stream 100 matches or partially matches an entry in any one of the content addressable memories 114, 116, 118, what is output to selection logic 120 is an index to the matching byte sequence and a representation of the bytes that did not match. The selection logic 120 chooses the output from one of the content addressable memories 114, 116, 118 to create a compressed representation of the matching byte sequence, which is then added to the output stream 150. It is preferable that the selection logic 120 chooses the output from the content addressable memory with the largest size or with the best partial match. Thus, for example, the selection logic 120 can proceed in a “greedy” manner, e.g., by first attempting to match the largest possible byte sequence using the widest content addressable memory, and, if there is no satisfactory match (full or partial), the second widest content addressable memory can be checked for matches—and so forth. As mentioned above, the matching processing at each content addressable memory 112, 114, 116 advantageously can proceed in parallel. The compression architecture continues to process matching byte sequences until the entire input stream 100 is completed and the final compressed stream 150 is output.

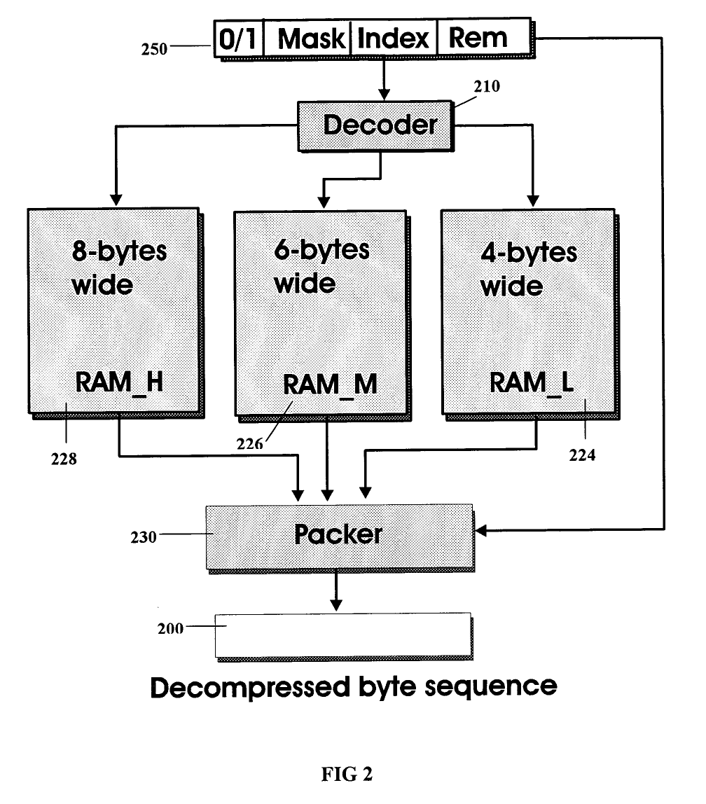

FIG. 2 is a block diagram of a corresponding decompression architecture which can receive the compressed stream 250, corresponding to 150 in FIG. 1, and recover the original stream 200. Decompression proceeds in a fashion that mirrors the above-described compression procedure. The compressed stream 250 is provided to a series of memory 224, 226, 228, which store the uncompressed byte sequences. There is no need to perform any matching of input data, so these memories need not be content addressable memories and can be, for example, conventional random access memories (RAMs). Each memory 224, 226, 228, is of a different size corresponding to the size of the content addressable memories in the compression architecture. The memories 224, 226, 228 are initially empty and are filled as the decompression progresses in the same fashion as they were filled during compression. When a representation of a compressed byte sequence is encountered in the compressed stream 250, a decoder 210 is utilized which extracts the index of the matching byte sequence and uses the index to retrieve the appropriate byte sequence from one of the memories 224, 226, 228. If the byte sequence is only a partial match, the representation of the bytes that did not match is also extracted to reconstruct the actual uncompressed byte sequence. Each uncompressed byte sequence is arranged at 230 so as to recover the original uncompressed stream 200.

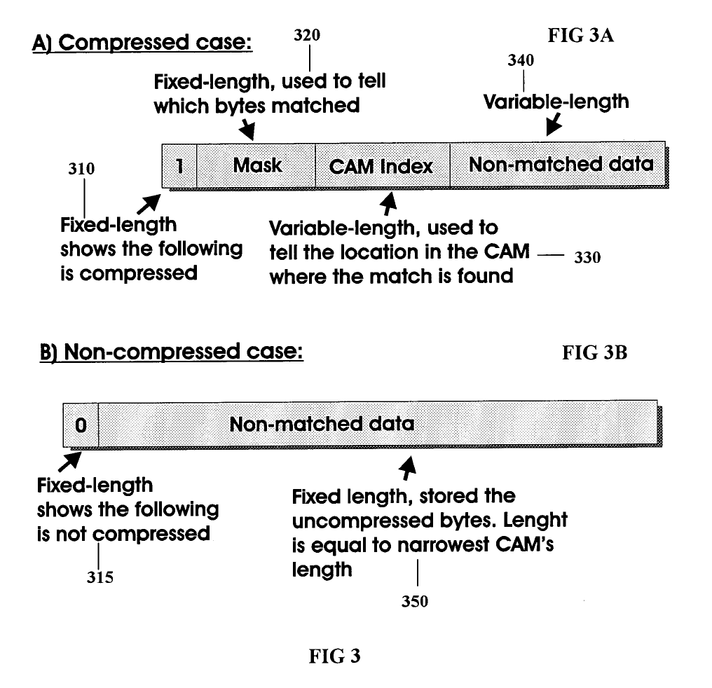

An advantageous example format for the compressed stream 150/250 is depicted in FIG. 3. FIG. 3A shows a format for when a portion of the original input stream can be compressed based on a partial or full match in the content addressable memories while FIG. 3B shows a format for when no match was found for the portion of the input stream. In FIG. 3A, the compressed case is signaled by a fixed length field 310, such as a most significant bit (MSB) which is set to one. Next, a fixed length mask 320 is stored which represents which bytes in the byte sequence matched. The bytes that did not match are stored at the end of the output in the field 340, while the field 330 stores the index in the content addressable memory that matched fully or partially the input byte sequence. Since there are multiple content addressable memories, it is also necessary to include information identifying which of the plurality of content addressable memories stores the matching byte sequence. It is preferable that the index also be used to signal which of the plurality of content addressable memories should be used. For example, in the case where three content addressable memories are used, the first CAM can be assigned indices 0, 3, 6, 9, . . . , while the second CAM is assigned 1, 4, 7, 10, . . . while the third CAM is assigned 2, 5, 8, 11, . . . , etc. In FIG. 3B, the uncompressed portion of the compressed stream is signaled by a MSB set to zero at 315 followed by the fixed length byte sequence 350. By setting the fixed length byte sequence to a set length equal to the width of the smallest content addressable memory, there is no need for any special encoding to specify the size of the uncompressed byte sequence.

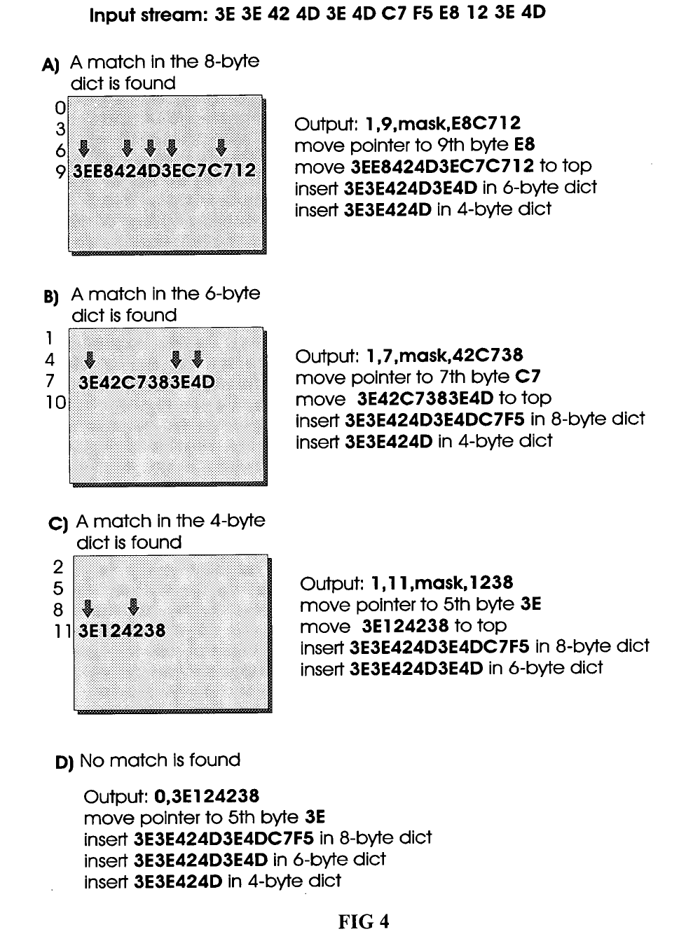

FIGS. 4A, 4B, 4C, and 4D further illustrate the different kinds of matches that can be handled by the three-CAM architecture depicted in FIG. 1. The four cases correspond, respectively, to a match in the widest content addressable memory, a match in the middle-size content addressable memory, a match in the narrowest content addressable memory, and finally no match at all. In all cases, for illustration, the same input stream is utilized, namely “3E 3E 42 4D 3E 4D C7 F5 E8 12 3E 4D.” In FIG. 4A, there is a match in the eight byte wide CAM where a total of five bytes match. The match is a partial one since not all bytes matched; however, it is satisfactorily large (namely five out of eight) to warrant using the eight-byte CAM. The output follows the format shown in FIG. 3. The output as shown in FIG. 4A is a “1” to signal the following data is compressed, a “9” for the index position in the CAM, followed by the mask field and finally the trailing bytes that did not match in the eight-byte CAM. In FIG. 4B and 4C, there is a match in the six-byte and the four-byte CAMs, respectively, with corresponding outputs. FIG. 4D shows the output for a case where there is no match. FIG. 4A, 4B, 4C, and 4D also illustrate an advantageous operation using the features of shiftable content addressable memories. At each cycle, the shiftable content addressable memories are modified as follows. The shiftable content addressable memory that contains the matching or partially matching data is shifted such that the matching or partially matching entry is moved to the top of the content addressable memory, while the non-matching content addressable memories are filled with the input data. Filling up all of the shiftable content addressable memories advantageously ensures early matching. Also, shifting the matching data to the top ensures that on average smaller CAM indices are stored which can use fewer bits. This is referred to as a “move-to-front” strategy.

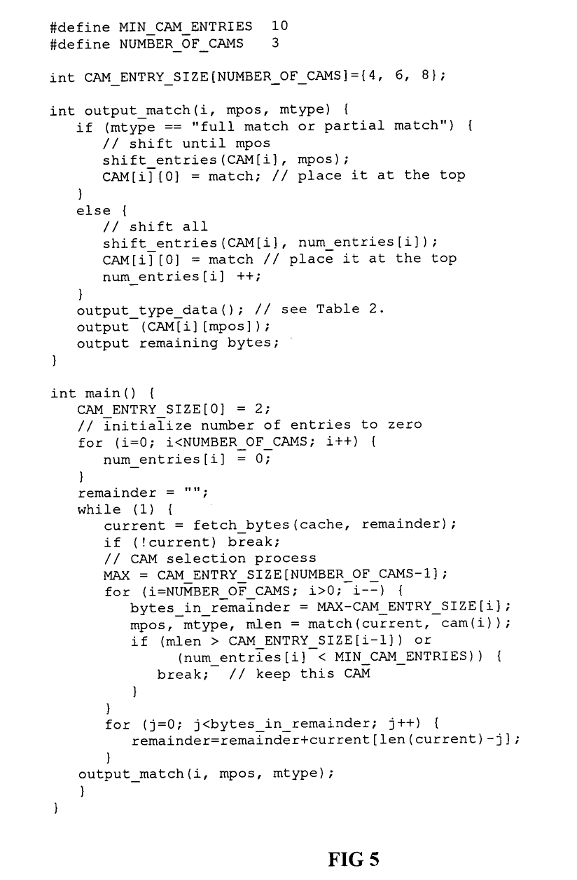

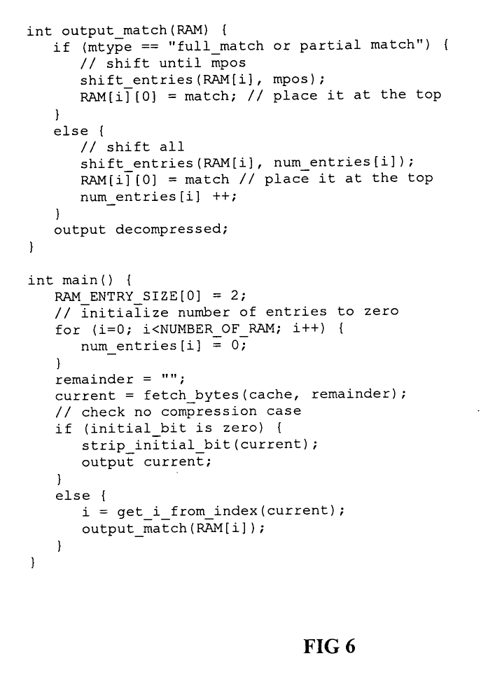

FIG. 5 is pseudo-code further illustrating the compression processing performed above in accordance with an embodiment of the present invention. FIG. 6 is pseudo-code further illustrating the corresponding decompression processing performed above in accordance with an embodiment of the present invention.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents. As but one of many variations, it should be understood that content addressable memories other than shiftable content addressable memories can be readily utilized in the context of the present invention.

What is claimed is:

1. A compression system comprising:
two or more content addressable memories, each of a different size, arranged to operate in parallel on different sized portions of an input stream; and
selection logic which, where there are one or more matching entries in the content addressable memories, chooses one of the matching content addressable memories so that one of the different sized portions in the input stream is replaced in a compressed output stream with a compressed representation identifying the chosen content addressable memory and its matching entry.

2. The compression system of claim 1 wherein the selection logic chooses one of the matching content addressable memories based on which memory has a longest matching entry.

3. The compression system of claim 1 wherein content addressable memories operate on partial matches as well as complete matches and wherein the selection logic chooses one of the matching content addressable memories based on which memory has a best partial matching entry.

4. The compression system of claim 3 wherein the compressed representation includes a mask identifying what parts of the portion of the input stream matched the matching entry and a representation of information in the portion of the input stream which did not match the matching entry.

5. The compression system of claim 1 wherein the content addressable memories add the different sized portions of the input stream as entries in the content addressable memories if there are no matches.

6. The compression system of claim 1 wherein the content addressable memories are shiftable and wherein they shift matching entries to a top of the content addressable memories.

7. The compression system of claim 1 wherein the compression system has three content addressable memories, each of different sizes.

8. The compression system of claim 6 wherein the three content addressable memories handle entries which are four bytes wide, six bytes wide, and eight bytes wide, respectively.

9. A decompression system comprising:
two or more memories, each of a different size; and
a decoder which reconstructs portions of a compressed stream by retrieving an entry from one of the two or more memories, the entry and the memory identified in a compressed representation of the portion as matching the portion of the uncompressed stream during compression.

10. The decompression system of claim 9 wherein the two or more memories add unmatched portions of the compressed stream as entries during decompression.

11. The decompression system of claim 9 wherein the decoder handles compressed representations of partial matches as well as complete matches.

12. The decompression system of claim 11 wherein the compressed representation includes a mask identifying what parts of the portion of the uncompressed stream matched the entry and a representation of information in the portion of the uncompressed stream which did not match the entry.

13. A method of compression comprising:
receiving different sized portions of an input stream;
performing parallel lookups in two or more content addressable memories on the different sized portions of the input stream, where each of the content addressable memories is of a different size corresponding to the different sized portions of the input stream; and
where there are one or more matching entries in any of the content addressable memories, choosing one of the matching content addressable memories and replacing the portion of the input stream matching the matching entry with a compressed representation in a compressed output stream, the compressed representation identifying the matching content addressable memory and its matching entry.

14. The method of claim 13 wherein the matching content addressable memory with the longest matching entry is chosen.

15. The method of claim 13 wherein the content addressable memories perform partial matches as well as complete matches and wherein the matching content addressable memory with a best partial matching entry is chosen.

16. The method of claim 15 wherein the compressed representation includes a mask identifying what parts of the portion of the input stream matched the matching entry and a representation of information in the portion of the input stream which did not match the matching entry.

17. The method of claim 13 further comprising the step, where there are no matching entries in the content addressable memories, adding the different sized portions of the input stream as entries in the content addressable memories.

18. The method of claim 13 wherein the content addressable memories are shiftable and wherein they shift matching entries to a top of the content addressable memories.

19. A method of decompression comprising:
receiving a compressed stream, the compressed stream comprising a sequence of compressed and uncompressed portions of different sizes;
decoding a next uncompressed portion in the sequence by storing the next uncompressed portion in one of two or more memories of different sizes, the sizes of the memories corresponding to the different sizes portions of the compressed stream; and
decoding a next compressed portion in the sequence into an uncompressed portion by retrieving an entry from one of the two or more memories, the entry and the memory identified in a compressed representation in the compressed portion;
where each decoded uncompressed portion is added to a sequence forming an uncompressed output stream.

20. The method of claim 19 wherein the compressed representation also includes a mask identifying what parts of the uncompressed portion matched the entry and a representation of information in the uncompressed portion which did not match the entry.
